(19) United States
(12) Patent Application Publication
(10) Pub. No.: US 2025/0111960 A1
(43) Pub. Date: Apr. 3, 2025

(54) IN-SITU FORMATION OF TWO-DIMENSIONAL (2D) NANOPARTICLES WITHIN ELASTOMERS FOR ELECTROCHEMICAL SENSING

(71) Applicants: Rutgers, The State University of New Jersey, New Brunswick, NJ (US); The Board of Regents of The University of Texas System, Edinburg, TX (US)

(72) Inventors: Jennifer K. Lynch-Branzoi, Belle Mead, NJ (US); Ali Ashraf, Tampa, FL (US); Ashiqur Rahman, Edinburg, TX (US); Nazmul Islam, Edinburg, TX (US)

(73) Assignees: Rutgers, The State University of New Jersey, New Brunswick, NJ (US); The Board of Regents of The University of Texas System, Edinburg, TX (US)

(21) Appl. No.: 18/827,374

(22) Filed: Sep. 6, 2024

Related U.S. Application Data
(60) Provisional application No. 63/580,912, filed on Sep. 6, 2023.

(51) Int. Cl. H01B 1/20; B01F 23/50; B01F 23/53; B01F 23/70; B01F 27/232; B01F 101/00; C08J 3/22; C08K 9/00; G01L 1/14; G01L 1/22; G01N 27/30; G06F 3/0354

(52) U.S. Cl. CPC H01B 1/20; B01F 23/511; B01F 23/53; B01F 23/70; B01F 27/2324; C08J 3/226; C08K 9/00; G01L 1/142; G01L 1/22; G01N 27/308; G06F 3/03547; B01F 2101/2805; B01F 2215/0431; B01F 2215/044; B01F 2215/0477; B01F 2215/0481; C08J 2383/04; C08K 2201/001; C08K 2201/004; C08K 2201/011

(57) ABSTRACT

Sensors employing elastomers enhanced with electrically conductive 2D nanoparticles are provided. The nanoparticles are formed by applying shear to layered materials present in elastomer precursors (e.g., elastomeric monomer(s) and/or curing agent(s)). Subsequent exfoliation of the layers occurs directly within the precursor and/or curing agent. The cured elastomer nanocomposites can be employed for electrochemical sensing, flexible touchpads, pressure sensors, and wireless sensors, amongst other applications.

### CROSS-REFERENCE TO RELATED APPLICATIONS

This application claims the benefit of U.S. Provisional Application. No. 63/580,912, filed on Sep. 6, 2023, and entitled “IN-SITU FORMATION OF TWO-DIMENSIONAL (2D) NANOPARTICLES WITHIN ELASTOMERS FOR ELECTROCHEMICAL SENSING”, the entirety of which is hereby incorporated by reference.

### STATEMENT OF GOVERNMENT SUPPORT

This invention was made with government support under grant ERI 2138574 awarded by the National Science Foundation (NSF). The government has certain rights in the invention.

### BACKGROUND

Elastomers are a thermoset type of polymer, which are highly viscoelastic in nature, which are formed by combining precursors, including the elastomer monomer, and curing agent, to induce polymerization and curing. Elastomers and rubber-based composites with conductive fillers provide several advantages compared to conventional rigid sensors. Conductive elastomeric polymer and rubber-based composites are capable of withstanding large strain in multiple directions, are biocompatible, lightweight, consume low power, and can be stretchable, flexible, and therefore wearable. Due to these unique properties, these sensors can be incorporated into clothes, gloves, garments, and even directly on the skin.

### SUMMARY

Elastomers with different fillers such as graphite (flake or powder), graphene, carbon nanotube (CNT), and carbon black (CB) have been employed to fabricate sensors with different techniques. For example, polydimethylsiloxane (PDMS)/graphite flake composites (40%, 45%, 50% wt. ratio) have been fabricated by simply mixing them with a curing agent as capacitive touch sensors. PDMS/CNT composites have also been developed using ultrasonication and pouring in a frame/template, and this sensor was then employed to sense different human motions such as finger/elbow joint/wrist/knee bending, drinking, and walking. Based on room-temperature-vulcanized (RTV) silicone rubber reinforced with CNT, nanographite (GR), and CNT-GR hybrids, a flexible strain sensor and actuator has been fabricated using solution mixing.

Among different conductive fillers, graphene (single, few, and multi-layer) and exfoliated graphite are of great interest due to their exceptional mechanical properties, thermal and electrical conductivities, stability, and large surface areas. This class of graphene-enhanced elastomeric composite, henceforth referred to as G-EMC, depends on the unique properties of both graphene/graphite and elastomer/rubber to sense its environment. Under external load, the distance between graphene in the composite and the structure of the hexagonal honeycomb will change, resulting in a change in the resistance of the composite sensor. Elastomeric materials are insulating in nature, thus when graphene is added at lower concentrations, the nanoparticles are unable to form a continuous route, which results in poor electrical conductivity in the composites. Electrons tunnel or hop from one graphene flake to another (if the filler content is above the percolation threshold in the composite), and that is why the change in distance between graphene flakes changes the resistance to electron flow.

In addition, these sensors show high sensitivity and minimal hysteresis, resulting in reproducible signals during repetitive movement of 1 Hz frequency. Besides strain sensors for human motion monitoring, G-EMCs can be used as a tactile sensor for touch screen displays, temperature sensing (since the electron tunneling effect is dependent on the temperature of the composite), pressure and flow sensing. Graphene natural rubber composite has been used for liquid solvent sensing, as exposure to solvent leads to swelling (i.e. change in distance between fillers), which increases the resistance of the composite.

Over the last decade, many researchers have shown the multifunctionality of this type of sensor. However, methods utilized to produce graphene are multi-step, expensive, and have the potential to include impurities during fabrication and transfer to the target polymer matrix. Moreover, the mixing of defect-free and inert pristine graphene with elastomers and rubber is inhomogeneous and leads to agglomeration in the matrix. Therefore, elastomers and rubbers like Polydimethylsiloxane (PDMS), Ecoflex™ and dragon-skin (platinum catalyzed silicone), and polyisoprene are usually mixed with functionalized nanofillers using several techniques, including melt processing, in-situ polymerization, and solution blending to fabricate G-EMC. Among these methods, melt processing shows the most potential for commercialization with certain limitations (poor dispersion, material degradation). All these limitations hinder the commercialization of G-EMC sensors.

Thus, while nanomaterials have shown tremendous promise in sensors, their use has been limited due to high-cost and complexity of production.

A 2D nanoparticle enhanced elastomeric nanocomposite (NP-EMC) is provided that possesses multifunctional sensing capabilities, including electrochemical sensing. As discussed in detail below, these nanocomposites can be created using an innovative, cost-effective, single-step in-situ shear exfoliation of the bulk layered material directly within elastomer precursors (monomer and/or curing agent). This innovative exfoliation technique leverages high shear and elongational forces generated during the rotation of a grooved single rotor. These forces overcome the interlayer van der Waals forces within bulk 2D materials, facilitating their exfoliation in elastomers. The elastomer serves as a stabilizer, and notably, the entire process avoids the use of toxic solvents or stabilizers, distinguishing it from other exfoliation techniques.

For example, a layered material (or combination of layered materials) such as graphite is exfoliated directly within one or both of the precursors of the elastomer, the elastomer monomer and/or curing agent, to shear the layers into graphene 2D nanoparticles (with a various number of layers in the c-axis direction) directly within the precursors to form graphite nanoflakes (GNFs). After subsequent mixing and curing of the filled precursor(s), an elastomer nanocomposite with 2D nanoparticle enhancement results. The GNF concentration, degree of exfoliation (number of layers in the c-axis direction), the elastomer precursor, and elastomer precursor to curing agent ratio can be varied to optimize resultant properties (e.g., mechanical, electrical, and/or thermal properties).

This addresses numerous issues in nanocomposite fabrication (e.g., nanomaterial contamination, expensive nanomaterial preparation step, agglomeration, hazardous solvent usage, low yield, non-uniform dispersion), which limits bulk production and application in various promising fields. Since the exfoliation process occurs in a pristine monomer envelope, the composite has impurity-free, few-layer graphene with better dispersion and good filler matrix bonding. This one step process eliminates the need to separately manufacture graphene nanoflakes. Instead, nanomaterial exfoliation from a low-cost bulk material (e.g., graphite) and uniform mixing happens simultaneously.

In an embodiment, a method of preparing an elastomeric composite is provided. The method includes exfoliating, by a batch mixer, at least one layered material within at least one of an elastomer precursor or a corresponding elastomer precursor curing agent. The method further includes mixing, by a planetary shear mixer, the elastomer precursor, the elastomer precursor curing agent, and the exfoliated layered material to provide a substantially homogenous mixture. The method additionally includes curing the homogenous mixture to form an elastomeric composite.

In another embodiment, the at least one layered material is selected from the group consisting of graphite, hexagonal boron nitride (HBN), molybdenum disulfide (MoS₂), tungsten disulfide (WS₂), MoSe₂, MoTe₂, WSe₂, TaSe₂, NbSe₂, NiTe₂, MoCl₂, PbI₂, MgBr₂, MnO₂, MoO₃, LaNb₂O₇, Mg₆Al₂(OH)₁₆, GaSe, Bi₂Te₃, Sb₂Se₃, TiSe₂, VS₂, NbS₂, TaS₂, VSe₂, NbSe₂, TaSe₂, VTe₂, NbTe₂, TaTe₂, PdTe₂, PtTe₂, montmorillonite (MMT), mica, vermiculite, talc, kaolinite, borophene, phosphorene, and any combination thereof.

In another embodiment, the layered material includes graphite flakes and the exfoliated layered material is graphene.

In another embodiment, the graphite flakes have an average length within the range from about 800 μm to about 2000 μm.

In another embodiment, mixing by the batch mixer is performed at a shear rate within the range from about 900 s⁻¹ to about 1600 s⁻¹.

In another embodiment, mixing by the batch mixer is performed for a time within the range from about 3 min to about 12.5 min.

In another embodiment, mixing by the planetary mixer is performed at a speed within the range from about 2500 rpm to about 3500 rpm.

In another embodiment, mixing by the planetary mixer is performed for a time within the range from about 1 min to about 3 min.

In another embodiment, a mixing ratio of the elastomer precursor and the elastomer precursor curing agent is about 4:1 to about 1:1 by weight.

In another embodiment, the elastomer is selected from the group consisting of polybutadiene, polyacrylonitrile, natural rubber, synthetic rubber, a polyesteramide, a chloroprene rubber, poly(styrene-butadiene), polysiloxane, polyisoprene, polyurethane, polychloroprene, chlorinated polyethylene, poly(ethylene glycol), a polyester/ether urethane, polyethylene, propylene, chlorosulphanated polyethylene, a polyalkylene oxide, a fluorosilicone, a highly saturated nitrile, a nitriles, a polyacrylate, a silicone, fluorinated ethylene propylene (FEP), a perfluoroelastomer, a copolymer of tetrafluoroethylene/propylene, a carboxylated nitrile, a fluoroelastomer, and mixtures thereof.

In another embodiment, the at least one layered material is present in a concentration of about 35% to about 50% by weight of the elastomeric composite.

In an embodiment, an electrochemical sensor is provided. The electrochemical sensor includes a substrate, the elastomeric composite formed according to any of the above-discussed embodiments, and a plurality of electrodes suitable for electrochemical sensing.

In another embodiment, the plurality of electrodes includes a counter electrode formed from platinum (Pt) and a reference electrode formed from silver/silver chloride (Ag/AgCl). In another embodiment,

In another embodiment, the elastomeric composite is a working electrode.

In another embodiment, the substrate includes at least one of fabrics, rubbers, plastics, metal, wood, electronic components, gloves, wrist bands, shoe soles, and belts.

In an embodiment, a touchpad is provided. The touchpad can include a substrate, at least one laminate positioned on a surface of the substrate, a first electrical contact, and a second electrical contact. The laminate can include the elastomeric composite formed according to any of the above-discussed embodiments. The first electrical contact can be positioned adjacent to a first surface of the elastomeric composite and configured to receive electrical power from a voltage source. The second electrical contact can be positioned adjacent to a second surface of the elastomeric composite, opposite the first surface, and configured for electrical communication with a load. The elastomeric composite and one of the first and second electrical contacts can be separated by a gap having a predetermined distance.

In another embodiment, the touchpad can include a spacer interposed between the elastomeric composite and the one of the first and second electrical contacts that defines the predetermined distance of the gap.

In another embodiment, the substrate can include at least one of fabrics, rubbers, plastics, metal, wood, electronic components, gloves, wrist bands, shoe soles, and belts.

In an embodiment, a pressure pad system is provided. The pressure pad system can include a pressure pad, a multiplexer, and a processor. The pressure pad can include a substrate and a laminate. The laminate can be positioned on a surface of the substrate and can include the elastomeric composite according to any of the above-discussed embodiments, a plurality of first electrodes and a plurality of second electrodes. The plurality of first electrodes can be positioned adjacent to a top surface of the elastomeric composite and can have a length oriented in a first direction the elastomeric composite. The plurality of second electrodes can be interposed between a bottom surface of the elastomeric composite and a top surface of the substrate and can have a length oriented in a second direction the elastomeric composite. One of the first and second plurality of electrodes is configured to receive electrical power from a voltage source. The multiplexer can be in electrical communication with each of the plurality of first and second electrodes. The processor can be in electrical communication with the multiplexer. The processor can be further configured to detect a resistance change between respective ones of the first and second plurality of electrodes in response to application of pressure, correlate each detected resistance change to an amount of applied pressure and location of the applied pressure with respect to pressure pad, and output one or more signals representing the amount and location of applied pressure with respect to the pressure pad.

In an embodiment, the substrate can include includes at least one of fabrics, rubbers, plastics, metal, wood, electronic components, gloves, wrist bands, shoe soles, and belts.

In an embodiment, a wireless sensor is provided. The wireless sensor can include a strain monitoring circuit and a second circuit. The strain monitoring circuit can include the elastomeric composite according to any of the above-discussed embodiments and a first inductor, where a resistance and capacitance of the elastomeric composite changes with strain. The second circuit can include a resistor, a second inductor, and a processor. The processor can be configured to measure an input return loss as a function of frequency.

### BRIEF DESCRIPTION OF THE DRAWINGS

These and other features will be more readily understood from the following detailed description taken in conjunction with the accompanying drawings, in which:

FIG. 1A is a schematic diagram illustrating a method for manufacturing a 2D nanoparticle enhanced elastomeric nanocomposite (NP-EMC) by in-situ exfoliation of a layered material by separately batch mixing with an elastomeric precursor and a corresponding elastomeric curing agent;

FIG. 1B is a schematic diagram illustrating a method for manufacturing an NP-EMC by in-situ exfoliation of graphite by batch mixing only with an elastomeric precursor;

FIG. 1C is a schematic diagram illustrating a method for manufacturing an NP-EMC by in-situ exfoliation of graphite by batch mixing only with an elastomeric curing agent;

FIG. 2 is a Raman spectrum of a graphite enhanced elastomeric nanocomposite (G-EMC) having a graphite loading of 35 and 40 wt. %;

FIG. 3A is a Raman spectrum of a G-EMC after a batch mixing time of 3 minutes;

FIG. 3B is a Raman spectrum of a G-EMC after a batch mixing time of 10 minutes;

FIG. 4A is a scanning electron microscope (SEM) image of a G-EMC surface at a first magnification;

FIG. 4B is a scanning electron microscope (SEM) image of the G-EMC surface of FIG. 4A at second magnification, greater than the first magnification;

FIG. 4C is a scanning electron microscope (SEM) image of the G-EMC surface of FIG. 4A at third magnification, greater than the second magnification;

FIG. 4D is a scanning electron microscope (SEM) image of the G-EMC surface of FIG. 4A at a fourth magnification, greater than the third magnification;

FIG. 5A is an SEM image at one position of a G-EMC surface after cryofracture;

FIG. 5B is an SEM image of surface of the G-EMC of FIG. 5A at another position after cryofracture;

FIG. 6A is a transmission electron microscope (TEM) image of a G-EMC surface at one location. The inset of FIG. 6A presents a magnified view of indicated area. Arrows indicate splitting and bending of graphene nanoflakes (GNFs);

FIG. 6B is a transmission electron microscope (TEM) image of the surface of the G-EMC of FIG. 6A at another location. The arrow indicates splitting and bending of graphene nanoflakes (GNFs);

FIG. 7A is a high-resolution C1s X-ray photoelectron spectroscopy (XPS) spectrum and curve fitting showing the contribution of different surface chemical functional groups and carbon types;

FIG. 7B presents C1s high-resolution XPS spectra for G-EMC with 4 wt. % and 40 wt. % graphite loading;

FIG. 7C presents an X-ray diffraction (XRD) pattern of a G-EMC;

FIG. 7D presets XRD spectra for G-EMC having graphene loadings of 10 wt. %, 15 wt. %, and 40 wt. %;

FIG. 8A is a Nyquist plot for dopamine detection in the range of 12.5 μM to 400 μM measured by an embodiment of an electrochemical sensor formed using an embodiment of a graphene-enhanced elastomeric composite (G-EMC);

FIG. 8B is a plot of charge transfer resistance as a function of dopamine concentration corresponding to the plot of FIG. 8A;

FIG. 9A is a schematic diagram of a flexible keypad/touchpad including keys including an embodiment of a G-EMC;

FIG. 9B is a diagram illustrating operation of a 5×2 array of the flexible keypad/touchpad of FIG. 2a that was assigned with individual light emitting diodes (LEDs);

FIG. 10A is a diagram illustrating a 2×2 array of a flexible keypad/touchpad having different sized keys (A1, A2, B1, B2) including an embodiment of a G-EMC;

FIG. 10B is a plot of relative resistance change as a function of time for individual key operation for the 2×2 touchpad/keypad of FIG. 10A;

FIG. 10C is a plot of change in peak resistance for each key of the 2×2 touchpad/keypad of FIG. 10A;

FIG. 11 is a diagram illustrating an embodiment of a forcepad/pressure pad including a G-EMC according to the present disclosure;

FIG. 12A is a plot of initial voltage at locations of intersecting electrodes of the forcepad/pressure pad of FIG. 11;

FIG. 12B is a plot of final voltage at the locations of intersecting electrodes of the forcepad/pressure pad of FIG. 11;

FIG. 12C is a plot of resistance change at the locations of intersecting electrodes of the forcepad/pressure pad of FIG. 11;

FIG. 13 is a schematic circuit diagram of a wireless sensor including a G-EMC;

FIG. 14 is a frequency response curve of a wireless sensor formed using the wireless sensor of FIG. 13;

FIG. 15A is a schematic illustration of a wireless podiatric pad sensor receiver;

FIG. 15B is a schematic illustration of a wireless podiatric pad sensor transmitter; and

FIG. 15C is plot illustrating a resistance change map using 10 G-EMC sensors to measure foot pressure at various locations.

It is noted that the drawings are not necessarily to scale. The drawings are intended to depict only typical aspects of the subject matter disclosed herein, and therefore should not be considered as limiting the scope of the disclosure.

### DETAILED DESCRIPTION

A 2D nanoparticle enhanced elastomeric nanocomposite (NP-EMC) is provided that possesses multifunctional sensing capabilities, including electrochemical sensing. As discussed in detail below, these nanocomposites can be created using in-situ shear exfoliation of the bulk layered material directly within elastomer precursors (monomer and/or curing agent components).

In general, a layered material (or combination of layered materials) such as graphite is exfoliated directly within one or both of the precursors of the elastomer (e.g., the elastomer monomer and/or curing agent) to shear the layers into graphene 2D nanoparticles (with a various number of layers in the c-axis direction) directly within the precursors to impart uniform, high shear. As discussed in greater detail below, this exfoliation technique leverages high shear and elongational forces generated during the rotation of a grooved single rotor. These forces overcome the interlayer Van der Waals forces within bulk 2D materials, facilitating their exfoliation in elastomers. The elastomer serves as a stabilizer, and notably, the entire process avoids the use of toxic solvents or stabilizers, distinguishing it from other exfoliation techniques. The single-step process ensures that the produced exfoliated material is inherently contamination-free and evenly dispersed, and the process is time-saving and environmentally friendly.

After subsequent mixing and curing of the precursors, an elastomer nanocomposite with 2D nanoparticle enhancement results (also referred to herein as an elastomeric composite). Parameters of the elastomeric nanocomposite, including but not limited to, the concentration of the layered material within the elastomeric nanocomposite, the degree of exfoliation of the layered material (number of layers in the c-axis direction), the elastomer composition (e.g., elastomeric precursor and elastomeric precursor curing agent), and the ratio of elastomeric precursor to elastomeric precursor curing agent, can be varied to optimize resultant properties of the elastomeric composite and/or structures incorporating the elastomeric composite (e.g., mechanical, electrical, and/or thermal properties).

For example, a method of fabricating the NP-EMC can include providing an unfilled elastomeric polymer precursor, a corresponding unfilled elastomeric curing agent, and one or more layered materials. At least one of the layered materials is capable of being exfoliated into electrically conductive 2D nanoparticles. The at least one layered material can be added to at least one of the elastomeric precursor or elastomeric curing agent and mixed using a batch mixer.

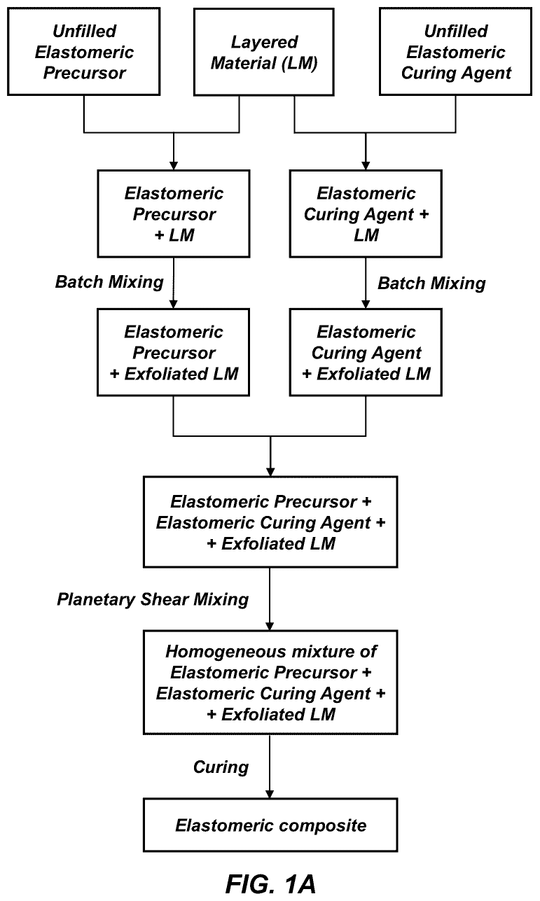

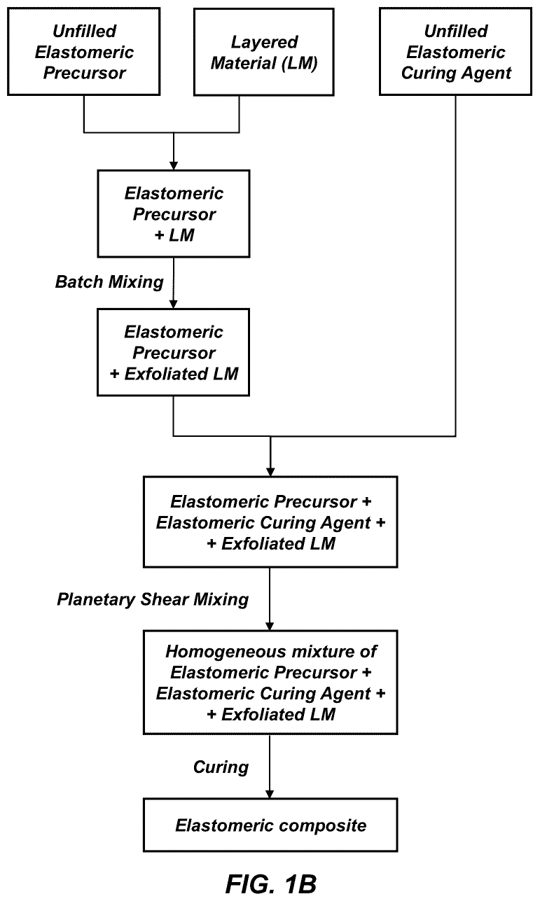

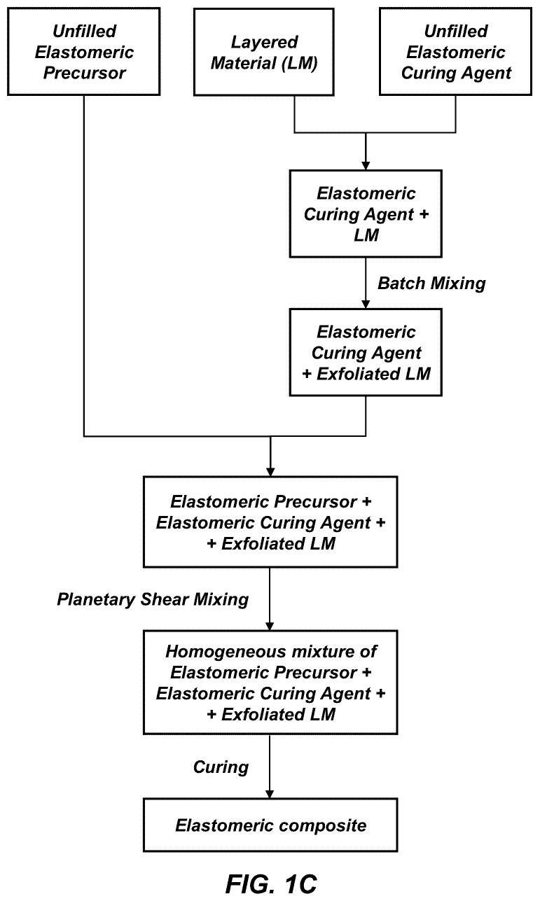

In one example, the layered material (LM) is added to both the elastomer precursor and the elastomer precursor curing agent (FIG. 1A). The elastomeric precursor+layered material and the elastomeric curing agent+layered material is each is mixed separately. In the mixing process, the batch mixer applies shear to the combination of the layered material in the elastomer precursor or layered material in the elastomer precursor curing agent at a level and for a time sufficient to exfoliate the layered material until 2D nanoparticles are formed and distribute the 2D nanoparticles substantially homogeneously within the elastomer precursor and elastomer precursor curing agent. Thus, a 2D nanoparticle-filled elastomer precursor and a 2D nanoparticle-filled curing agent, or both can be formed. The method additionally includes combining the filled or unfilled elastomer precursor with the filled or unfilled curing agent in a suitable ratio based on the elastomer type and concentration of layered material.

In another example, the layered material (LM) is added to one of the elastomer precursor and the elastomer precursor curing agent (FIGS. 1B-1C) and batch mixed.

The combination of exfoliated 2D nanoparticles, elastomer precursor, and elastomer precursor curing agent is further mixed (e.g., using a planetary mixture) to form a substantially homogenous (uniform) mixture. The homogeneous mixture is then cured to form the NP-EMC.

### Materials

### Elastomer

The elastomer precursor can be a low molecular weight elastomeric oligomer selected from the group consisting of polybutadiene, butadiene copolymers, acrylonitrile copolymers, natural and synthetic rubber, polyesteramides, chloroprene rubbers, poly(styrene-butadiene) copolymers, polysiloxanes (such as polydimethylsiloxane (PDMS) (silicone oil)), polyisoprene, poly urethanes, polychloroprene, chlorinated polyethylene, polyethylene glycols (polyethylene oxides), polyester/ether urethanes, polyethylene, propylene, chlorosulphanated polyethylene, polyalkylene oxides, fluorosilicones, highly saturated nitriles (HSN, HNBR), nitriles, poly acrylates, silicone, fluorinated ethylene propylene (FEP), perfluoroelastomers (such as SIMRIZR), copolymers of tetrafluoroethylene/propylene (such as AFLASR), carboxylated nitriles, fluoroelastomers (such as a dipolymer of hexafluoropropylene and vinylidene fluoride, e.g. Dupont™ VITON®), and mixtures thereof.

The elastomer precursor curing agent can be selected based on compatibility with the elastomer precursor and the desired end use application.

### Layered Materials

A suitable layered material (or combination of layered materials) can include, but is not limited to graphite, hexagonal boron nitride (HBN), and transition metal dichalcogenides (TMDs) (e.g., MoS₂, MoSe₂, MoTe₂, WSe₂, TaSe₂, NbSe₂, NiTe₂). Such layered materials may also include, without limitation, metal halides (e.g., MoCl₂, PbI₂, MgBr₂), layered metal oxides (e.g., MnO₂, MoO₃, LaNb₂O₇), layered double hydroxides (LDHs) (e.g., Mg₆Al₂(OH)₁₆), layered silicates or clays (e.g., montmorillonite (MMT), micas, vermiculite, talc, kaolinite), III-VI layered semiconductor (e.g., GaSe), layered V-VIs (e.g., Bi₂Te₃, Sb₂Se₃), layered a and y zirconium phosphates and phosphonates, layered double hydroxides (LDHs), ternary transition metal carbides and nitrides, metal trichalcogenides, and metal trihalides.

### Examples

A graphite-enhanced elastomeric composite (G-EMC) is fabricated from graphite and a silicone-based elastomer.

In a non-limiting example, Ecoflex™-00-30 Part A and Ecoflex™-00-30 Part B can be provided as the elastomeric precursor and the elastomeric precursor curing agent, respectively. About 35-50% graphite by weight is separately mixed with each of the silicone precursor and the curing agent in a batch mixer. During the mixing, the graphite is converted into graphene nanoflakes (GNFs) directly within the elastomeric precursor and elastomeric curing agent. This obtains a homogenous mixture of nanoparticle (graphene nanoflake) filled silicone precursor and nanoparticle filled curing agent.

For example, batch mixing can be performed at a speed sufficient to achieve a target shear rate. The shear rate (j) can be given by the following Equation 1:

$$\dot{γ} = \frac{2 π * R * w}{s} \qquad ( Eq . l )$$

where R is the radius of the rotor of the batch mixer, w is the rotor speed (RPM), and s is the gap between the rotor and stator of the batch mixer. As R and s are parameters of the batch mixer, a target shear rate can be achieved by operating the batch mixer at a target speed.

In general, the target shear rate employed using the batch mixer for exfoliation may be greater than or equal to a shear rate sufficient to overcome the interlayer shear strength of the nanoparticles (e.g., GNFs). In a non-limiting embodiment, the shear rate may be within the range between about 900 s⁻¹ to about 1600 s⁻¹. In an embodiment, a shear rate of about 900 s⁻¹ (corresponding to a speed of about 100 rpm) was employed.

It is further appreciated that the time of mixing is taken into consideration as well. With increasing mixing time, the degree of graphite exfoliation into GNFs increases, and the distribution of the number of layers in the GNFs decreases. The GNF-matrix interaction is very strong, since each newly exfoliated GNF has a pristine surface, and fracturing across the AB Basal plane of the GNFs provides reactive sites with the potential for primary covalent bonding between GNF edges and the surrounding medium (either the polymer precursor or the curing agent) thereby providing in situ functionalization. However, while application of shear for an extended time may result in better (more complete) exfoliation and homogenization, the elastomeric precursor can degrade and/or the nanoparticles can break into smaller pieces, which can ultimately inhibit curing of the elastomeric precursor. Accordingly, batch mixing for exfoliation and homogenization is performed for a time within the range between about 3 min to about 20 min.

The nanoparticle filled silicone precursor (G+Ecoflex™-A) is then combined with the nanoparticle filled curing agent (G+Ecoflex™-B) in a predetermined ratio. In general, the ratio of the precursor to curing agent can be within the range from about 4:1 to 1:1 by weight. In the instant example, a ratio of 1:1 was used.

Subsequently, the combination of nanoparticle filled silicone precursor is combined with the nanoparticle filled curing agent and mixed using a planetary mixer to provide a homogenous mixture prior to curing. The planetary mixing can be performed at a predetermined shear rate corresponding to a rotational speed within the range between about 2500 rpm to about 3500 rpm for about 1 minute to about 3 minutes. For example, in the instant example, planetary mixing was performed for about 2 minutes to get homogenous mixing.

Subsequently, the mixed nanoparticle filled silicone precursor and nanoparticle filled curing agent are allowed to cure, according to the manufacturer's curing conditions. Curing is a phenomenon where the nanoparticle composite composition transforms from a liquid/semi-solid state to a solid state. As shown in Table 1 below, graphite having three different sizes was investigated to examine the effect of graphite size on curing.

TABLE 1
Different graphite configurations and their sizes

| Graphite Type | Size (μm) | Manufacturer |
|---|---|---|
| Graphite Powder | 20 | Fisher Chemicals |
| Graphite Flake | 270 | ACS Materials LLC |
| Graphite Flake | 850 | Asbury Carbons (USA) |

With changing graphite size, curing phenomena were affected for the nanocomposites, as shown in Table 2.

TABLE 2
Curing phenomena for different sizes of graphite

| | | Exfoliation | Mixing Ratio of | |
|---|---|---|---|---|
| | Size | Time | precursor and curing | Curing |
| | (μm) | (min) | agent | Status |
| Graphite Powder | 20 | 3-10 | 1:1 | No cure |
| Graphite Flake | 270 | 3-10 | 1:1 | No cure |
| Graphite Flake | 850 | 3-10 | 1:1 | Cured |

As the composition including larger graphite flake (850 μm) resulted in curing, the effect of exfoliation time (batch mixing time) for this graphite flake was further examined. The results are shown below in Table 3.

TABLE 3
Curing phenomena for different exfoliation
time (850 μm graphite flake; 1:1 ratio)

| Exfoliation Time | |
|---|---|
| (min) | Curing Status |
| 3 | Cured |
| 8.5 | Cured |
| 10 | Cured |
| 12 | Cured |
| 20 | No cure |

Accordingly, it can be appreciated that both the size of the layered materials prior to exfoliation, as well as the exfoliation time, affected the curing phenomenon of the elastomer nanocomposites.

### Sensor Fabrication

G-EMC sensors (e.g., 25×10×1.5 mm³) fabricated from NP-EMCs prepared using 850 μm graphite and cured according to Table 2 were tested for their applicability to electrochemical sensing, flexible touchpads, and wireless sensing. However, graphite or other layered materials having suitable size (e.g., largest dimension), shape, and concentration can be employed provided that the elastomeric composition is capable of curing. For example, graphite flakes having an average size (e.g., average longest dimension/average length) within the range of about 800 μm to about 2000 μm.

### Characterization

Raman spectroscopy is acquired from a G-EMC sample prepared with its top surface polished using coarse grade emery paper. A Renishaw in Via reflex system equipped with a 633 nm laser and 50× magnification in was employed to acquire the Raman spectra. Raman spectroscopy is a reliable, rapid, and nondestructive technique to determine the number of graphene layers exfoliated, and induced defects in the structure during the formation of graphene along with some other properties in a carbon-based material.

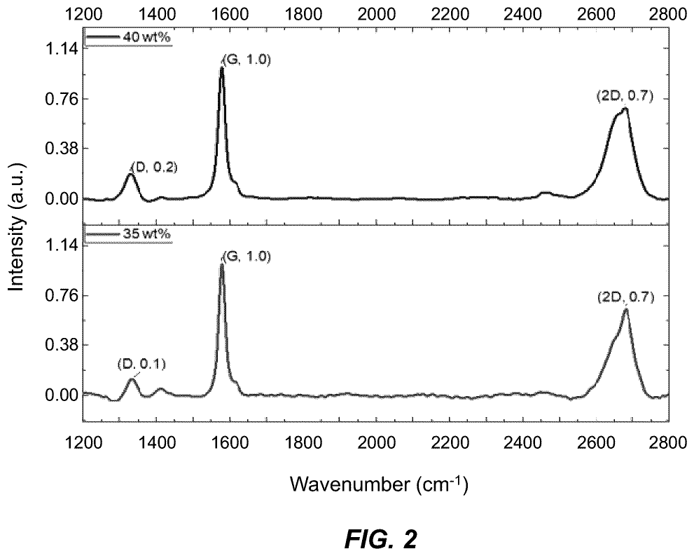

Raman spectra of 35 and 40 wt. % G-EMC sensor is shown in FIG. 2. The G band (appearing at ˜1580 cm⁻¹) indicates the number of graphene layers, and it moves to lower frequencies as the number of layers increases. The D band, indicative of disorder and dependent on defect extent such as disruptions in the carbon honeycomb lattice arising from edges, grain boundaries, in-plane vacancies, or carbon hybridization changes, manifests at approximately 1350 cm⁻¹. Notably, the D band peak intensity is higher for 40 wt. % G-EMC sensors as compared to 35 wt. % G-EMC.

The defect density can be assessed through the calculation of the I_{D}/I_{G} intensity ratio between the D and G bands, where an elevation in the D band intensity (and thus the I_{D}/I_{G} ratio) is attributed to particle size reduction, reflecting increased edge defects per unit volume in smaller particles. Besides, this ratio can also be exploited to find the formation of covalent bonds between the exfoliated graphene and elastomer matrix. As increased time and increased wt. % loading of graphite exhibits a higher intensity of I_{D} peak (normalized intensity increases from 0.1 to 0.2), it is expected that better exfoliation and better bonding occurrent in the 40% wt. G-EMC nanocomposite.

The I_{2D}/I_{G} ratio can also be used as an indicator to determine the number of layers in CVD-grown graphene. However, the relationship between the I_{2D}/I_{G} ratio and the number of layers is different for CVD-grown graphene versus exfoliated graphene. Thus, a modified calculation was employed according to Backes et al. (Spectroscopic Metrics Allow in Situ Measurement of Mean Size and Thickness of Liquid-Exfoliated Few-Layer Graphene Nanosheets. Nanoscale 2016, 8 (7), 4311-4323), incorporated herein by reference in its entirety.

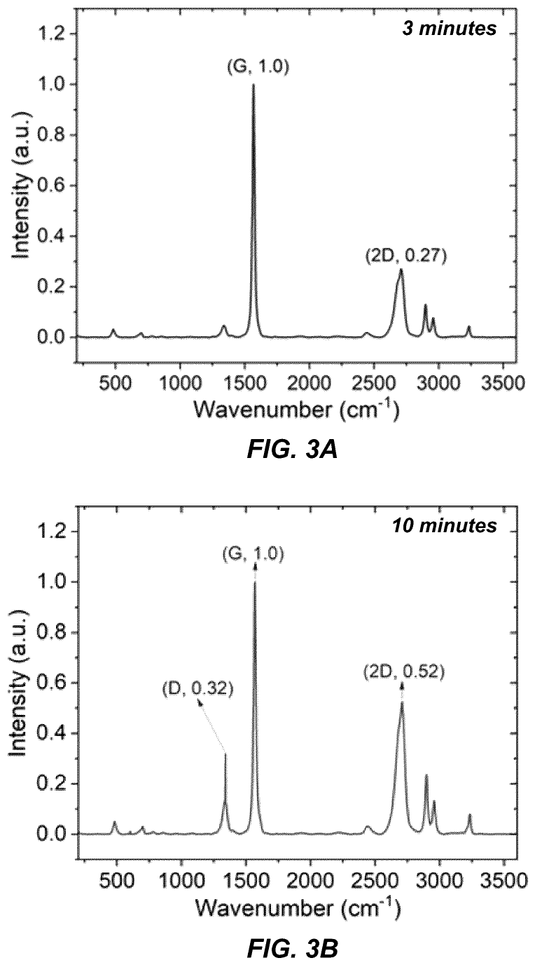

With longer mixing time and an increase in the degree of graphite exfoliation, the intensity ratio increases (as I_{2D}) increases) suggesting a reduction of thickness in the c-direction of the GNFs (better exfoliation). The 2D band appears at ˜2700 cm⁻¹, and both 40 wt. % G-EMC & 35 wt. % G-EMC showed a similar 2D band intensity. The normalized intensity of the 2D band is 0.7 in comparison to the G band, indicating that few graphene layers were formed during graphene exfoliation (batch mixing time: 20 minutes). After 3 minutes (FIG. 3A), the I_{2D}/I_{G} band intensity was lower than after 10 minutes (FIG. 3B), indicating a higher number of graphene layers.

Degree of exfoliation, dispersion and surface morphology is further analyzed using scanning electron microscopy (SEM) at different magnifications. Samples were mounted on typical aluminum studs with carbon black tape, and gold coated with a thickness of 5 nm before imaging.

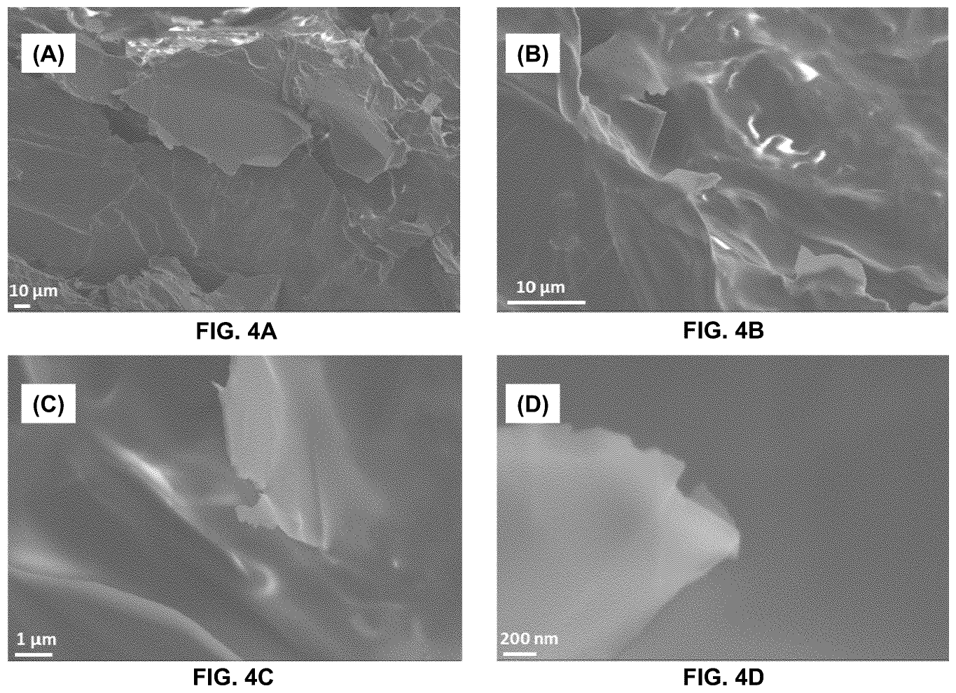

Initially, the lateral dimension of the graphite flakes was 850 microns. FIGS. 4A-4D, it is evident that the lateral dimension of the graphite flake after exfoliation has reduced significantly. This reduction to smaller particle size contributes to the better dispersion and matrix-nanomaterial interfacing. Exfoliation from graphite to few layered graphene creates new surfaces as it broke in basal plane provide active sites in edge and in other locations, which promotes surface crystallization of polymer for bonding with nanomaterial. Due to the interfacial affinity, surface roughness and higher surface area for reduced lateral dimension, the graphene sheets uniformly disperse throughout the polymer matrix without any agglomeration.

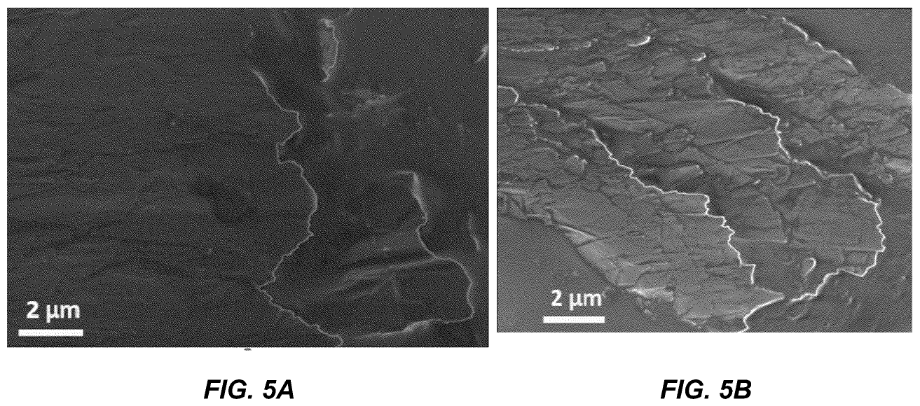

To gain more insight into the arrangement of GNFs inside polymer matrix, the G-EMC samples are cryo-fractured using an ultramicrotome and subsequently imaged by SEM. As shown in FIG. 5A, the GNFs are embedded in the soft elastomer and the nano composite surface is uneven. A few GNFs protrude through the matrix, and a reduced number of voids and separations are observed, indicating strong adherence of the GNFs at the interface to the elastomer matrix. As shown in FIG. 5B, in some places, transparent GNFs are visible, indicating GNFs with few layers.

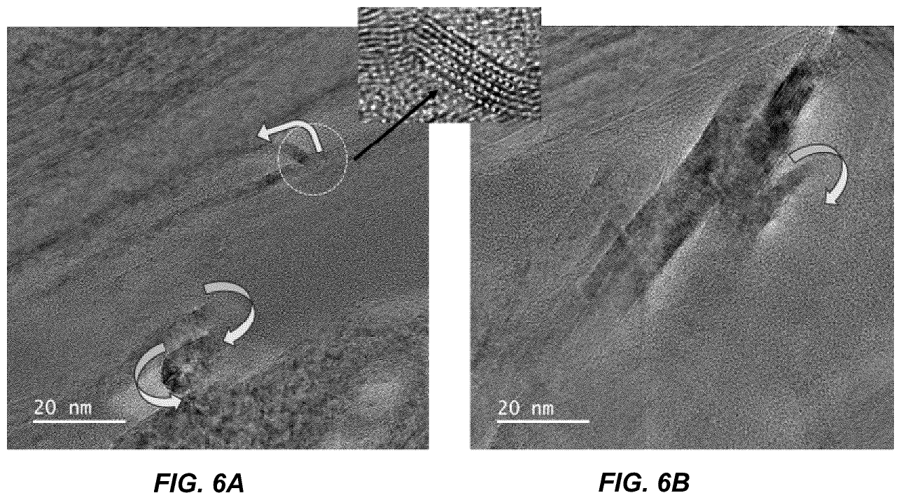

Analysis at different areas of a sample from transmission electron microscopy (TEM) is illustrated in FIGS. 6A-6B. As shown, ISE can result in GNFs with ˜6 layers. Additionally, these TEM images show splitting and bending of GNFs inside the polymer matrix, which is consistent with the expected shear and elongation forces experienced during batch mixing.

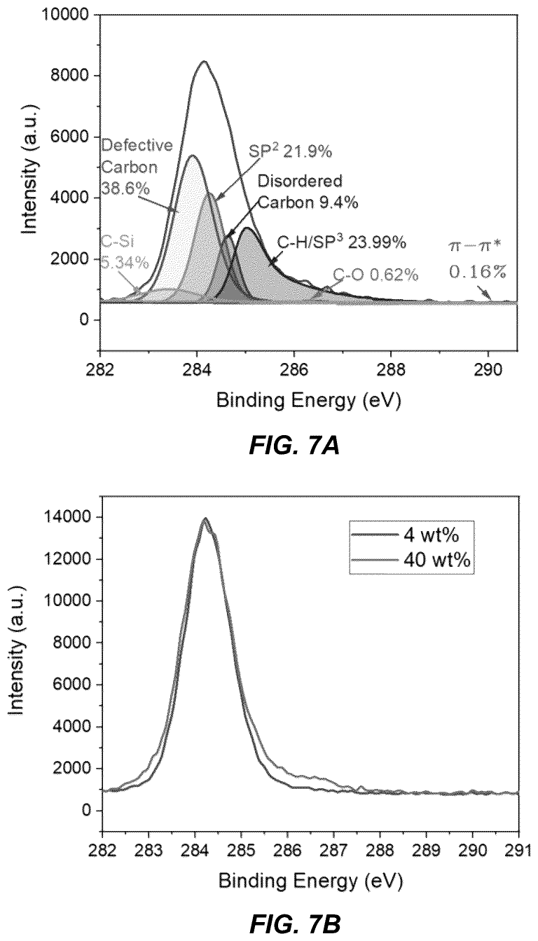

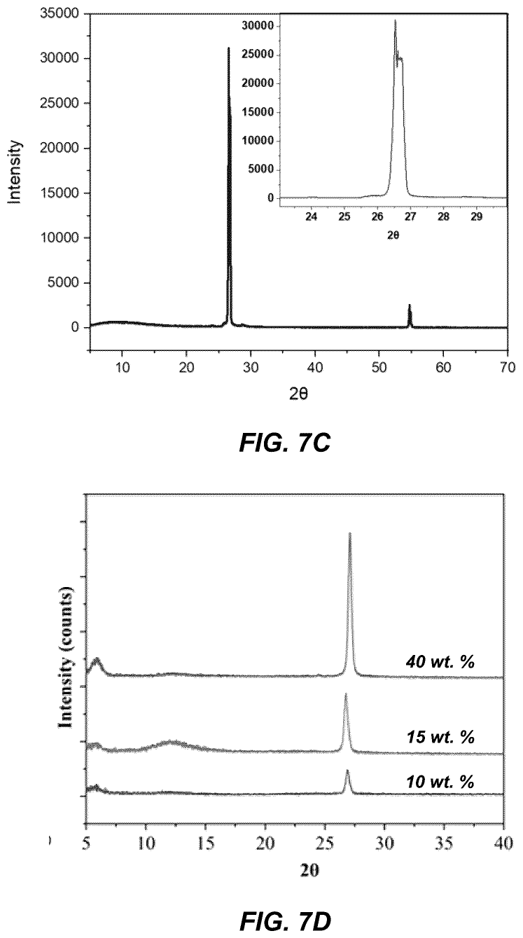

The surface compositions of G-EMC sample cross-sections are analyzed using X-ray photoelectron spectroscopy (XPS) are shown in FIGS. 7A-7D. The XPS spectra are obtained using a Thermo Scientific™ K-Alpha XPS instrument with an Al—Kα x-ray anode. X-ray energy is 1486.6 eV and 10 scans are performed over a 400 μm square window for the acquisition of high-resolution spectra. Thermo Scientific™ Advantage Data System is used for background subtraction, peak fitting, and atomic composition calculation.

The peak positions used to analyze the data are presented in Table 4 below.

TABLE 4
XPS curve fitting with peak positions
assigned for 40 wt. % G-EMC

| | | Full Width at Half Maximum |
|---|---|---|
| Peak Assignment | Peak BE (eV) | (FWHM) |
| sp² | 284.24 | 0.73 |
| Defective Carbon | 283.89 | 0.94 |
| Disordered Carbon | 284.62 | 0.51 |
| π-π* | 290.36 | 0.48 |
| C—O | 286.37 | 0.77 |
| C—H/sp³ | 285 | 0.87 |
| C—Si | 283.4 | 1.44 |

FIG. 7 presents a high-resolution C1s spectrum of 40 wt. % G-EMC. As shown, the oxygen content in the nanocomposite was very low, less than 1%. This indicates in-situ shear exfoliation results in pristine graphene exfoliation, free of impurity or oxygen functional group formation. The prominent defective carbon peak at 283.9 eV indicates the breakage in the basal plane of graphene sheets, leading to the formation of graphene flakes with smaller lateral dimensions and rich edge sites for enhanced bonding with polymer molecules. This demonstrates that the in-situ shear exfoliation process not only exfoliates from graphite to fewer layered graphene but also breaks the basal layer to a smaller size. This finding is consistent with the SEM and Raman results.

The disordered carbon peak relates to the silicone polymer in the composite. The C—Si and C—H/sp³ peaks can relate to both the bonding between polymer molecules and between graphene and polymer. The broad weak peak at 290.5 eV is related to the π-π* shake-up transition. The C1s core-level spectra of the G-EMC with higher loading of graphite are more asymmetric when compared to lower loading, as shown in FIG. 7B.

From their intensity difference spectrum, it can be observed that the enhanced contribution from C—Si, defective and sp² results in the intensity difference in ˜283-284 eV region, and an additional contribution from the C—H bond at ˜285 eV region. Therefore, these results indicate successful exfoliation, edge site formation, and enhanced bonding in the G-EMC composite.

FIG. 7C is an X-ray diffraction XRD spectrum of a G-EMC sample, further showing a prominent peak at ˜26.5°, indicating good exfoliation and dispersion of graphene nanoflakes in elastomer. Also, the secondary peak occurring at ˜55° can be attributed to random orientation of the nanoflakes. The peak corresponding to (0 0 2) plane at ˜26.5° is a combination of several peaks, as can be seen in the inset of FIG. 7C, and results from graphene nanoflakes with different number of layers.

FIG. 7D shows XRD spectra for graphene loadings of 10 wt. %, 15 wt. %, and 40 wt. %. As shown, an increase of peak intensity is observed with loading and can be attributed to the interfacial adhesion between the nanomaterial and the polymer matrix due to surface crystallization and hydrogen bonding between carbon and polymer matrix.

### Electrochemical Sensing

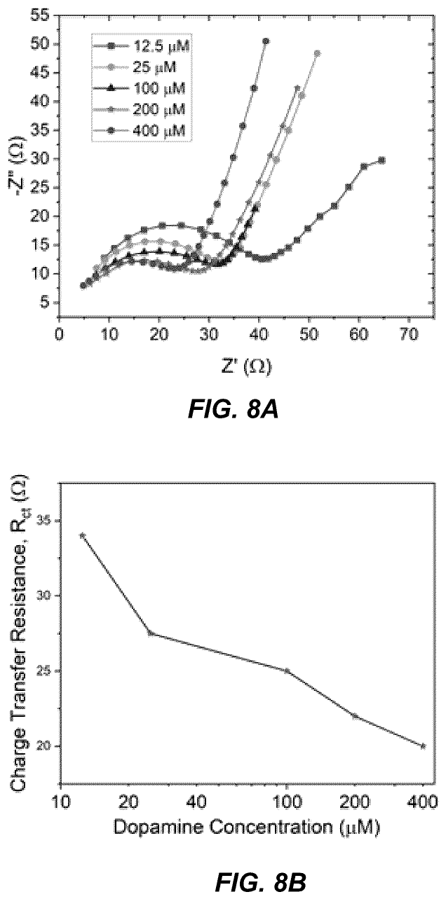

Electrical impedance spectroscopy (EIS) is carried out to evaluate the performance of dopamine detections for electrochemical sensing. A Nyquist plot (imaginary vs. real part of impedance) is shown in FIG. 8A for dopamine concentration from 12.5 μM to 400 μM. The charge transfer resistance, Ret (diameter of semicircle formed in FIG. 8A) decreases with the increase of concentration. The decrease in charge transfer resistance (FIG. 8B) can be described as the G-EMC surface being in contact with more dopamine biomolecules and the kinetics of charge transfer to the electrode material is improving (surface improvement).

### Flexible Touchpad Keypad

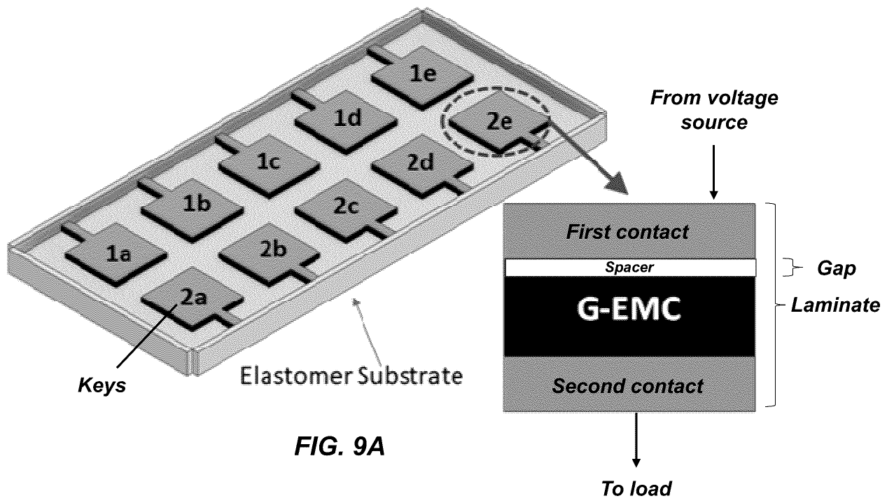

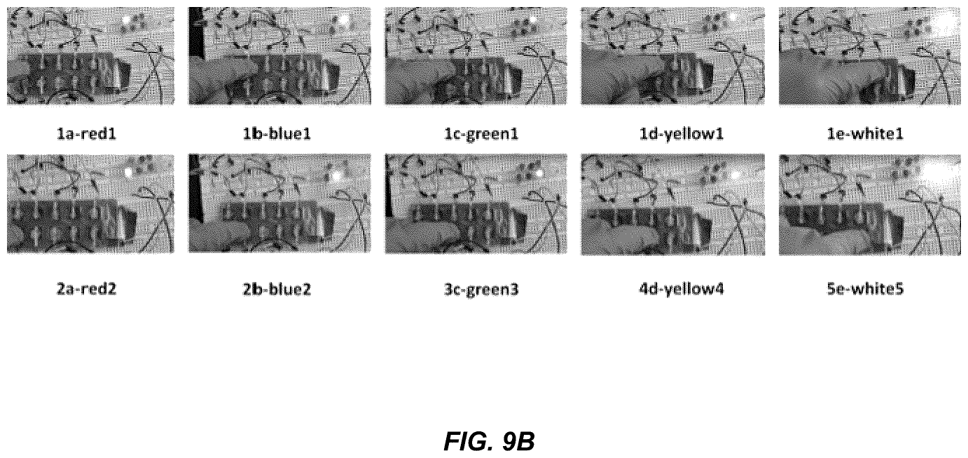

A flexible keypad/touchpad is desirable for durability and water-resistance, making it suitable for use in a variety of environments. Because embodiments of the G-EMC sensors have high electrical conductivity and flexibility, a flexible keypad/touchpad with 10 sensors functioning as keys was fabricated in a 5×2 configuration, as illustrated in FIG. 9A.

As shown, the touchpad/keypad includes an elastomeric substrate and flexible laminates that function as the keys. For example, each laminate is positioned on a surface of the substrate and includes a first electrical contact, the G-EMC, and a second electrical contact, with the G-EMC sandwiched between the first and second electrical contacts. One of the contacts of each laminate can be in electrical communication with a voltage source (e.g., the first electrical contact) and the other contact of each laminate can be in electrical communication with an electrical load (e.g., the second electrical contact). The contacts may be formed from any suitable electrically conductive material. In an example, the contacts may be formed from copper.

A spacer is further provided between one of the contacts (e.g., the first contact) and the G-EMC to form a gap therebetween. When the laminate is a pressed or touched, a force is applied to the contact distanced from the G-EMC, causing this contact to bend elastically and to contact the G-EMC. This closes the electric circuit between the voltage source and the load, allowing current to flow from the voltage source, across the laminate, to the load. When the press or touch is released, the contact which underwent bending returns to its original position, distanced from the G-EMC. As a result, the electric circuit becomes open and current flow from the voltage source to the load stops.

By optimizing the gap between an electrode and the G-EMC, the sensitivity of the keypad/touchpad can be tailored to detect relatively light pressure for fine-touch or motion detection.

To test this configuration, a sample touchpad/keypad is fabricated using copper tape for each of the first and second contact, a 5 V source provided via Arduino™ Uno R3 as the voltage source, and light emitting diode (LEDs) as the load for respective keys of the touchpad/keypad. As key is depressed, its G-EMC makes a connection with the Cu tapes. Thus, current can pass through the laminate, causing the corresponding LED to power on, as illustrated in FIG. 9B.

It can be appreciated that the touchpad can be fabricated with layouts of the keys using the above-discussed G-EMC laminates without limit.

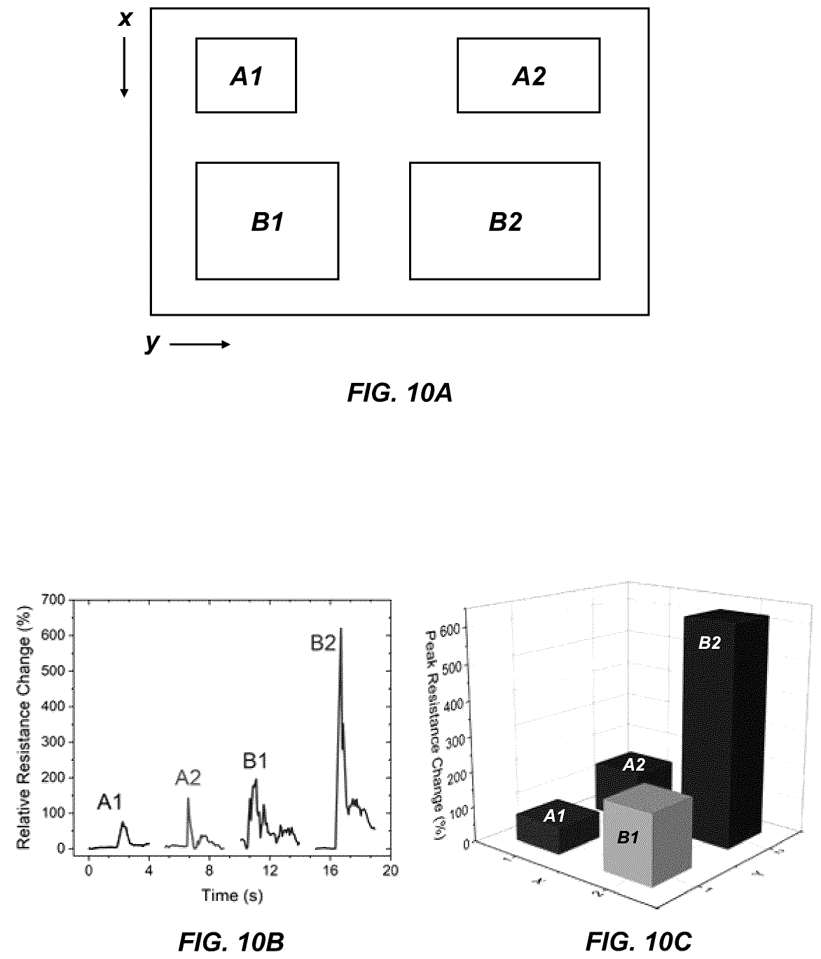

In further embodiments, the size of the G-EMC keys can be varied, resulting in different peak resistances for current flowing therethrough when touched/pressed. As a result, the operation of individual keys can be distinguished from one another. An example is illustrated in FIG. 10A for a 2×2 keypad having rows A-B (y-axis) and columns 1-2 (x-axis) (e.g., keys A1, A2, B1, B2). As shown in FIGS. 10B-10C, each of the keys A1, A2, B1, B2 can be formed such that their relative resistance change as a function of time (FIG. 3b) and peak resistance change (3c) can be measurably different.

### Forcepad Pressure Pad

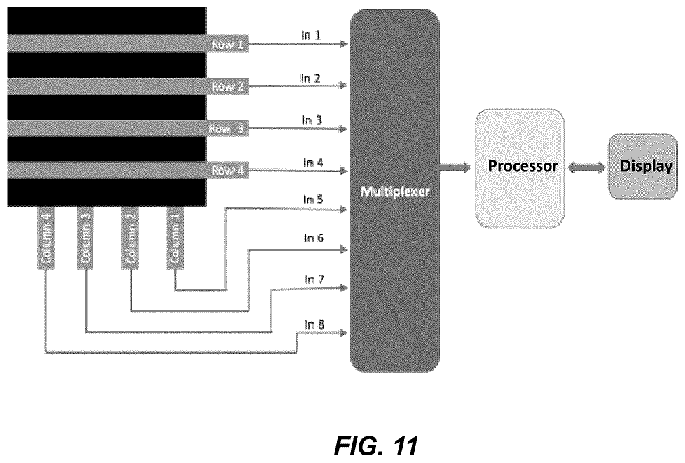

FIG. 11 is a schematic illustration of a forcepad/pressure pad fabricated using G-EMC (about 10 cm×10 cm) as a laminate, similar to FIGS. 9A-9B, except using a different electrode configuration. Four row electrodes (1-4) are positioned on one side of the G-EMC (e.g., a top side) and four column electrodes are positioned on the other side of the G-EMC (e.g., a bottom side). In this configuration, the electrodes on respective sides of the G-EMC intersect each other at 16 locations in the plane of the device.

Each of the row and column electrodes is further connected to a respective input of a multiplexer. The output of the multiplexer is received by a processor. The processor can further output signals for viewing on a display.

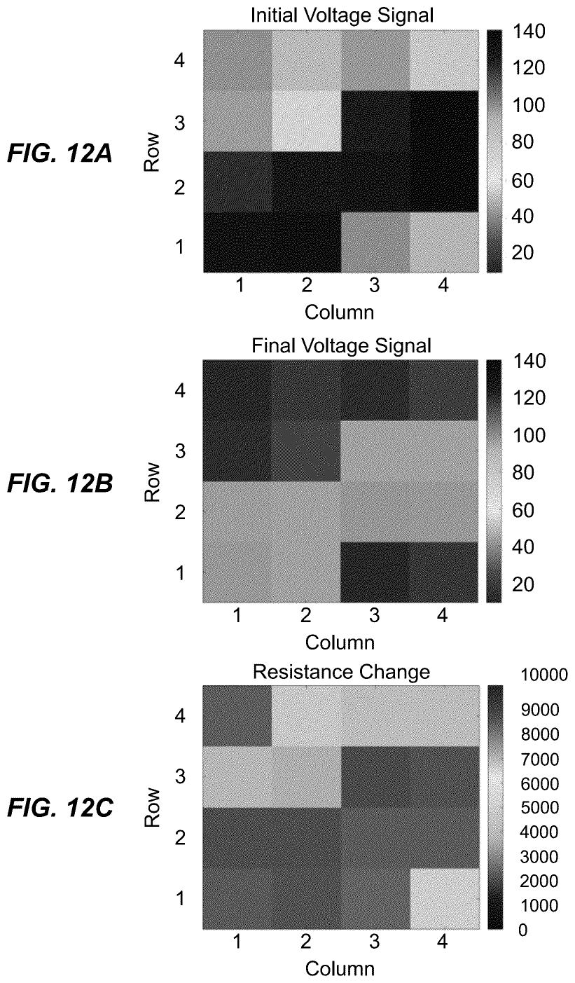

If pressure is applied to any of the 16 intersection locations, a resistance change proportional to the applied force occurs. By measuring the resistance change, it can be correlated with the force/pressure applied to that specific location. For example, FIG. 12A illustrates initial voltage signals measured as a function of the 16 intersection locations, prior to pressing the forcepad/touch pad. FIG. 12B illustrates final voltage signals measured as a function of the 16 intersection locations after the forcepad/touch pad is pressed. FIG. 12C illustrates the change in resistance determined from the input and final at the 16 intersection locations.

Using known resistances with a series to all the sensors, unknown resistance value of the sensor can be obtained by voltage divider law. A 5V positive voltage is applied in one end of the known resistance, the junction between known resistance and unknown sensor value is connected to the multiplexer, and the other end of the sensor pad is connected to the ground voltage. The unknown sensor resistance increases proportionally with the applied pressure, junction (between the known resistor and unknown sensor, hence referred as junction) voltage decreases as the voltage drop across the sensor pad increases.

On the other hand, the 8 junction voltage values are connected to a multiplexer, and using digital signals, the multiplexer sends each junction voltage signal via a single output pin. Beneficially, this configuration saves total analog input pins for Arduino™ Uno. Prior to the pressing, the voltage drop in the intersection locations is low, therefore a high junction voltage signal is obtained. On the other hand, the junction voltage decreases when pressure is applied to the intersection locations. The voltage change is then converted into resistance change for each of the locations using the voltage divider law.

### Wireless Sensing

Traditional sensors require a battery power supply to acquire signals in monitoring systems, increasing the complexity. Thus, battery-powered sensors cannot always be easily adjusted, as it is not always feasible to employ in hostile situations or in-vivo biomedical applications. Thus, wireless sensing technology have yet to become a viable feature for avoiding active electronics and has drawn attention in recent years.

A passive resistor-inductor-capacitor (RLC) strain monitoring circuit based on the flexible NP-EMCs discussed herein in combination with a wireless readout mechanism can provide the ability to eliminate any active circuit elements in the implant. The approach utilizes resonant frequency measurement by a sensor including the NP-EMC and the readout system including a network analyzer or impedance analyzer. The readout system and the strain monitoring circuit communicate signal wirelessly via electromagnetic inductive coupling.

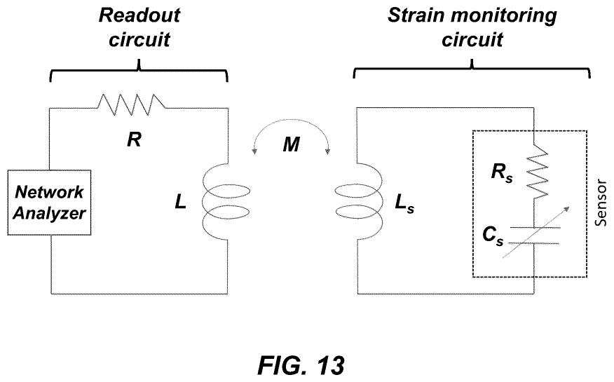

This concept can be implemented using an embodiment of the NP-EMCs discussed herein, as shown in FIG. 13. As shown, the strain monitoring circuit includes a series RLC circuit with variable resistance and capacitance that changes with strain. Variable resistance and capacitance are provided by the NP-EMC (e.g., a G-EMC). The NP-EMC is provided in series with an inductor coil. The readout circuit includes a readout inductor coil and network analyzer or impedance analyzer.

A corresponding shift in the RLC resonant frequency signal of the strain monitoring circuit can be wirelessly read using mutual induction between the strain monitoring circuit inductor coil and readout circuit induction coils. The resonant frequency of the strain monitoring circuit is represented as:

$${f}_{s} = \frac{1}{2 π \sqrt{{L}_{s} {C}_{s}}}$$

where Lₛ and Cₛ denote the inductance and capacitance, respectively.

To test this configuration, a copper coil with a wire diameter of 1.5 mm is used for each of the inductor coils. The coil inductances of the strain monitoring circuit and readout circuit are 11.6 μH and 11 μH, respectively. The frequency response of the strain monitoring circuit is remotely monitored through the minimum of the input return loss (S₁₁) in the readout circuit using an HP8752C network analyzer.

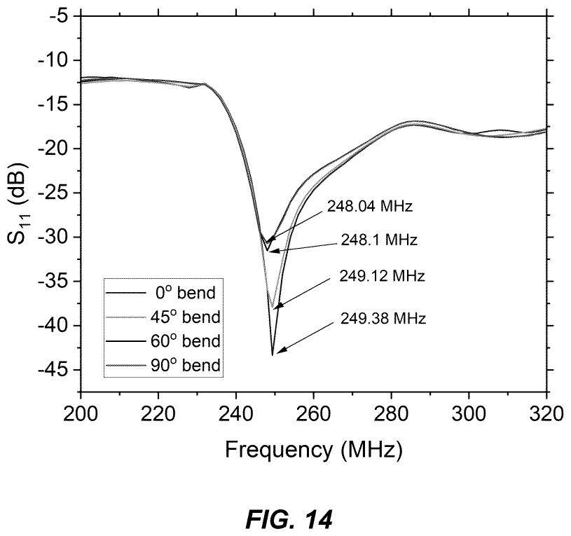

Due to bending at different angles around a roller gauge of diameter 43 mm, a change in capacitance and resistance is observed in the G-EMC. Input return loss (S₁₁) with frequency for bending at different angles of the elastomer (e.g., 0°, 45°, 60°, 90°) is shown in FIG. 14. It can be observed that the resonant frequencies of the G-EMC remain closely in the range of about 250 MHz for each of the different bending angles. In contrast, the signal amplitude gradually decreases as the bending increases from 0° to 90°. The decrease in amplitude signifies the change in resistance of the strain sensing circuit, and the small peak shift is due to the change in capacitance of the G-EMC. From these results, it can be concluded that the passive wireless RLC circuit including the G-EMC enables reliable signal detection.

### Wireless Podiatric Pad

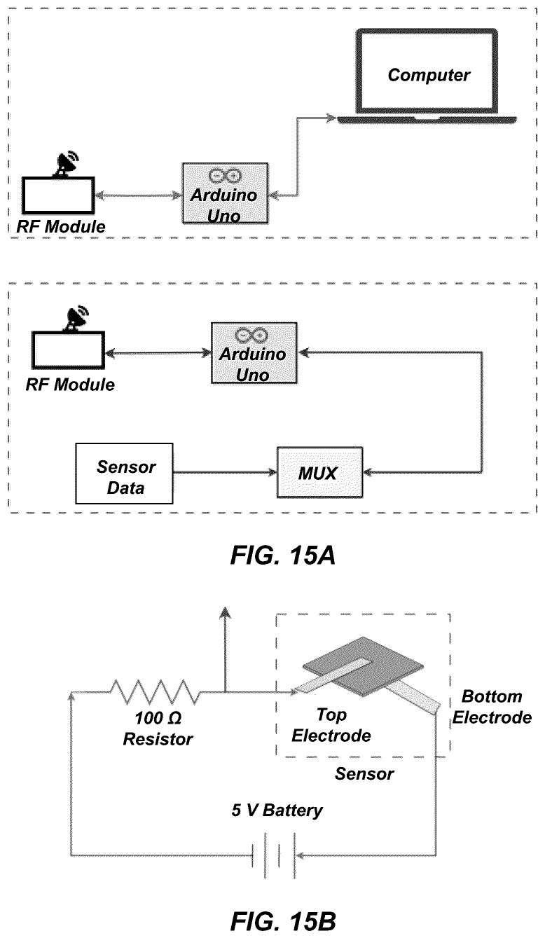

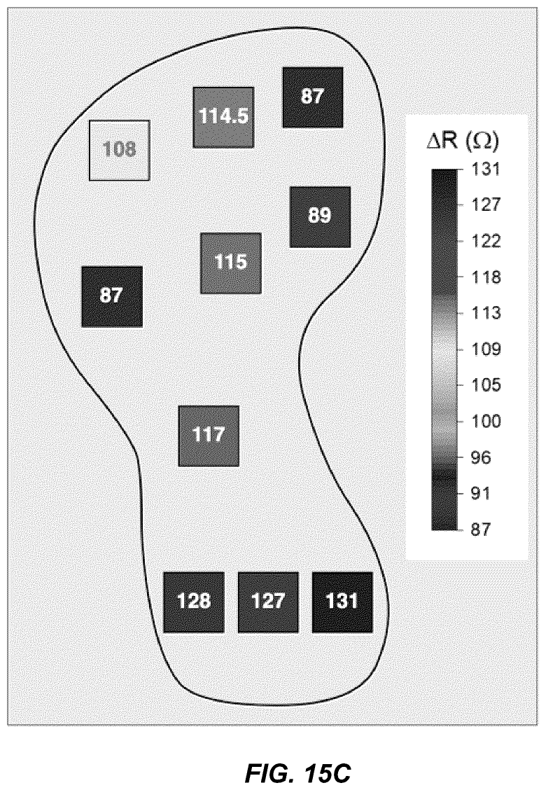

As the G-EMC sensor is both flexible and piezoresistive in nature, a wireless podiatric pad using the G-EMC sensor is fabricated to measure the plantar surface pressure. The pressure information at 10 important points can reveal the loading characteristics of a patient. A transceiver was used in conjunction with a processing system including a processor and memory (e.g., Arduino™ Uno) to make the sensor pad wireless, as shown in FIG. 15A.

The electrodes were connected to a known resistance (100 (2) and the junction voltage (the point between known resistor and sensor) data was sent to the Arduino™ Uno via a multiplexer (MUX), as illustrated in FIG. 15B. The Arduino™ Uno processes the data and sends it to the RF module to transmit the signal to the receiver end. Using the Arduino™ Uno and processing software in the receiver end computer, the resistance change of 10 different positions of a volunteer is obtained (weight: 164 lb., height: 5 ft 8 inch), as shown in (FIG. 15C). The pressure distribution can be calibrated by applying a known pressure on the sensor as pressure varies proportionally with resistance change. The GNFs move apart when a pressure/force is applied to the G-EMC sensor as previously mentioned. The resolution of the podiatric pad can be increased using more sensors. Furthermore, this low-cost, sensitive, and reliable podiatric pad can be used in healthcare applications, especially in detecting different podiatric diseases.

Exemplary technical effects of the methods, systems, and devices described herein include, by way of non-limiting example nanoparticle-enhanced elastomeric composites (NP-EMCs) formed by in-situ shear exfoliation of a bulk layered material directly within elastomer precursors. These NP-EMCs can be formed in relatively few steps and relatively low cost, facilitating broader use.

These NP-EMCs (e.g., graphene enhanced elastomeric composites, G-EMCs), which incorporate in-situ graphene formation from graphite, showcase a versatile range of capabilities and can be further employed in a wide variety of sensing applications, including electrochemical sensors, flexible touchpads, and wireless sensors. The G-EMC sensor exhibits notable performance in electrochemical sensing of dopamine, within concentration ranges of 12 μM to 400 μM and with charge transfer resistance varying from 34Ω to 20Ω. Flexible keypads, incorporating these highly conductive G-EMC sensors can also be fabricated. The inclusion of a low-cost, passive wireless sensor, operating without a power source, further enhances the sensor's versatility. By detecting the resonance frequency, this passive wireless sensor can assess various physical activity signals, making it suitable for remote health monitoring. These multifunctional, environment-friendly, and low-cost G-EMC sensors hold great promise for a range of applications, particularly in revolutionizing flexible electronics and healthcare applications.

Certain exemplary embodiments have been described to provide an overall understanding of the principles of the structure, function, manufacture, and use of the systems, devices, and methods disclosed herein. One or more examples of these embodiments have been illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

One skilled in the art will appreciate further features and advantages of the disclosed embodiments based on the above description and accompanying drawings. Accordingly, the present application is not to be limited by what has been particularly shown and described, except as indicated by the appended claims. All publications and references cited herein are expressly incorporated by reference in their entirety.

1. A method of preparing an elastomeric composite, comprising:
exfoliating, by a batch mixer, at least one layered material within at least one of an elastomer precursor or a corresponding elastomer precursor curing agent;
mixing, by a planetary shear mixer, the elastomer precursor, the elastomer precursor curing agent, and the exfoliated layered material to provide a substantially homogenous mixture; and
curing the homogenous mixture to form an elastomeric composite.

2. The method of claim 1, wherein the at least one layered material is selected from the group consisting of graphite, hexagonal boron nitride (HBN), molybdenum disulfide (MoS₂), tungsten disulfide (WS₂), MoSe₂, MoTe₂, WSe₂, TaSe₂, NbSe₂, NiTe₂, MoCl₂, PbI₂, MgBr₂, MnO₂, MoO₃, LaNb₂O₇, Mg₆Al₂(OH)₁₆, GaSe, Bi₂Te₃, Sb₂Se₃, TiSe₂, VS₂, NbS₂, TaS₂, VSe₂, NbSe₂, TaSe₂, VTe₂, NbTe₂, TaTe₂, PdTe₂, PtTe₂, montmorillonite (MMT), mica, vermiculite, talc, kaolinite, borophene, phosphorene, and any combination thereof.

3. The method of claim 1, wherein the layered material comprises graphite flakes and the exfoliated layered material is graphene.

4. The method of claim 3, wherein the graphite flakes have an average length within the range from about 800 μm to about 2000 μm.

5. The method of claim 1, wherein mixing by the batch mixer is performed at a shear rate within the range from about 900 s⁻¹ to about 1600 s⁻¹.

6. The method of claim 1, wherein mixing by the batch mixer is performed for a time within the range from about 3 min to about 12.5 min.

7. The method of claim 1, wherein mixing by the planetary mixer is performed at a speed within the range from about 2500 rpm to about 3500 rpm.

8. The method of claim 1, wherein mixing by the planetary mixer is performed for a time within the range from about 1 min to about 3 min.

9. The method of claim 1, wherein a mixing ratio of the elastomer precursor and the elastomer precursor curing agent is about 4:1 to about 1:1 by weight.

10. The method of claim 1, wherein the elastomer is selected from the group consisting of polybutadiene, polyacrylonitrile, natural rubber, synthetic rubber, a polyesteramide, a chloroprene rubber, poly(styrene-butadiene), polysiloxane, polyisoprene, polyurethane, polychloroprene, chlorinated polyethylene, poly(ethylene glycol), a polyester/ether urethane, polyethylene, propylene, chlorosulphanated polyethylene, a polyalkylene oxide, a fluorosilicone, a highly saturated nitrile, a nitriles, a polyacrylate, a silicone, fluorinated ethylene propylene (FEP), a perfluoroelastomer, a copolymer of tetrafluoroethylene/propylene, a carboxylated nitrile, a fluoroelastomer, and mixtures thereof.

11. The method of claim 1, wherein the at least one layered material is present in a concentration of about 35% to about 50% by weight of the elastomeric composite.

12. An electrochemical sensor, comprising:
a substrate;
the elastomeric composite formed according to claim 1; and
a plurality of electrodes suitable for electrochemical sensing.

13. The electrochemical sensor of claim 12, wherein the plurality of electrodes includes a counter electrode formed from platinum (Pt) and a reference electrode formed from silver/silver chloride (Ag/AgCl).

14. The electrochemical sensor of claim 12, wherein the elastomeric composite is a working electrode.

15. The electrochemical sensor of claim 12, wherein the substrate includes at least one of fabrics, rubbers, plastics, metal, wood, electronic components, gloves, wrist bands, shoe soles, and belts.

16. A touchpad, comprising:
a substrate;
at least one laminate positioned on a surface of the substrate, the laminate including:
the elastomeric composite formed according to claim 1;
a first electrical contact positioned adjacent to a first surface of the elastomeric composite; and configured to receive electrical power from a voltage source; and
a second electrical contact positioned adjacent to a second surface of the elastomeric composite, opposite the first surface, and configured for electrical communication with a load;
wherein the elastomeric composite and one of the first and second electrical contacts is separated by a gap having a predetermined distance.

17. The touchpad of claim 16, further comprising a spacer interposed between the elastomeric composite and the one of the first and second electrical contacts that defines the predetermined distance of the gap.

18. The touchpad of claim 16, wherein the substrate includes at least one of fabrics, rubbers, plastics, metal, wood, electronic components, gloves, wrist bands, shoe soles, and belts.

19. A pressure pad system, comprising:
a pressure pad, including:
a substrate; and
a laminate positioned on a surface of the substrate, the laminate including:
the elastomeric composite formed according to claim 1;
a plurality of first electrodes positioned adjacent to a top surface of the elastomeric composite and having a length oriented in a first direction the elastomeric composite:
a plurality of second electrodes interposed between a bottom surface of the elastomeric composite and a top surface of the substrate and having a length oriented in a second direction the elastomeric composite;
wherein one of the first and second plurality of electrodes is configured to receive electrical power from a voltage source:
a multiplexer in electrical communication with each of the plurality of first and second electrodes; and
a processor in electrical communication with the multiplexer and configured to:
detect a resistance change between respective ones of the first and second plurality of electrodes in response to application of pressure;
correlate each detected resistance change to an amount of applied pressure and location of the applied pressure with respect to pressure pad; and
output one or more signals representing the amount and location of applied pressure with respect to the pressure pad.

20. The pressure pad of claim 19, wherein the substrate includes at least one of fabrics, rubbers, plastics, metal, wood, electronic components, gloves, wrist bands, shoe soles, and belts.

21. A wireless sensor, comprising:
a strain monitoring circuit including:
the elastomeric composite formed according to claim 1, wherein a resistance and capacitance of the elastomeric composite changes with strain; and
a first inductor; and
a second circuit including:
a resistor;
a second inductor; and
a processor;
wherein the processor is configured to measure an input return loss as a function of frequency.
